(19) United States
(12) Patent Application Publication
(10) Pub. No.: US 2013/0135543 A1
(43) Pub. Date: May 30, 2013

(54) LIQUID CRYSTAL DIMMER, IMAGE PICKUP UNIT, AND METHOD OF DRIVING LIQUID CRYSTAL DIMMING DEVICE

(71) Applicant: Sony Corporation, Tokyo (JP)

(72) Inventors: Keita Kaifu, Tokyo (JP); Yuichi Yamamoto, Kanagawa (JP); Yasuyuki Seki, Kanagawa-Ken (JP); Yukiko Yamada, Kanagawa (JP)

(73) Assignee: SONY CORPORATION, Tokyo (JP)

(21) Appl. No.: 13/678,608

(22) Filed: Nov. 16, 2012

(30) Foreign Application Priority Data
Nov. 29, 2011 (JP) 2011-260059

(51) Int. Cl. G02F 1/133

(52) U.S. Cl. CPC G02F 1/13306
USPC 349/33

(57) ABSTRACT

A liquid crystal dimmer includes: a liquid crystal dimming device adjusting a transmitted light amount of incident picked-up image light; a driving section supplying a drive voltage for driving the liquid crystal dimming device to the liquid crystal dimming device; and a control section controlling the drive voltage to control a dimmed state of the liquid crystal dimming device. The control section controls the drive voltage to allow plural-stage shifting of a tilt angle of a liquid crystal molecule in the liquid crystal dimming device when the liquid crystal dimming device is caused to undergo a state transition from one dimmed state to another dimmed state, the dimmed states being different from each other in the transmitted light amount.

### BACKGROUND

The present disclosure relates to a liquid crystal dimmer that includes a liquid crystal dimming device and a driving section driving the liquid crystal dimming device, an image pickup unit that includes such a liquid crystal dimmer, and a method of driving a liquid crystal dimming device.

In general, an image pickup unit such as a digital camera (a digital still camera) includes an iris that mechanically performs a dimming operation (light amount adjustment) as a dimming device that adjusts a light amount of picked-up image light. In addition, in recent years, an electric dimming device (a liquid crystal dimming device) that uses a liquid crystal of a guest-host type (GH) or the like that contains a dichromatic coloring matter is proposed as an alternate function of such a mechanical iris (see, for example, Japanese Unexamined Patent Application Publication No. 2003-186078)

Japanese Unexamined Patent Application Publication No. 2003-186078 also discloses a method of driving a liquid crystal dimming device. Proposal of an appropriate technique that would improve disadvantages distinctive to a liquid crystal is desirable also with respect to such a method of driving a liquid crystal dimming device.

### SUMMARY

It is desirable to provide a liquid crystal dimmer and a method of driving a liquid crystal dimming device that allow appropriate driving of the liquid crystal dimming device, and an image pickup unit that includes such a liquid crystal dimmer.

According to an embodiment of the disclosure, there is provided a liquid crystal dimmer including: a liquid crystal dimming device adjusting a transmitted light amount of incident picked-up image light; a driving section supplying a drive voltage for driving the liquid crystal dimming device to the liquid crystal dimming device; and a control section controlling the drive voltage to control a dimmed state of the liquid crystal dimming device. The control section controls the drive voltage to allow plural-stage shifting of a tilt angle of a liquid crystal molecule in the liquid crystal dimming device when the liquid crystal dimming device is caused to undergo a state transition from one dimmed state to another dimmed state, the dimmed states being different from each other in the transmitted light amount.

According to an embodiment of the present disclosure, there is provided an image pickup unit including: a liquid crystal dimming device adjusting a transmitted light amount of incident picked-up image light; an image pickup device acquiring a picked-up image signal based on picked-up image light that exits from the liquid crystal dimming device; a driving section supplying a drive voltage for driving the liquid crystal dimming device to the liquid crystal dimming device; and a control section controlling the drive voltage to control a dimmed state of the liquid crystal dimming device. The control section controls the drive voltage to allow plural-stage shifting of a tilt angle of a liquid crystal molecule in the liquid crystal dimming device when the liquid crystal dimming device is caused to undergo a state transition from one dimmed state to another dimmed state, the dimmed states being different from each other in the transmitted light amount.

According to an embodiment of the present disclosure, there is provided a method of driving a liquid crystal dimming device, the method including: supplying a drive voltage to the liquid crystal dimming device to drive the liquid crystal dimming device, the liquid crystal dimming device adjusting a transmitted light amount of incident picked-up image light; and causing the liquid crystal dimming device to undergo a state transition from one dimmed state to another dimmed state, the dimmed states being different from each other in the transmitted light amount, while controlling the drive voltage to allow plural-stage shifting of a tilt angle of a liquid crystal molecule in the liquid crystal dimming device.

In the liquid crystal dimmer, the image pickup unit, and the method of driving a liquid crystal dimming device according to the embodiments of the present disclosure, when the liquid crystal dimming device is caused to undergo the state transition from one dimmed state to another dimmed state, these dimmed states being different from each other in transmitted light amount, the drive voltage is controlled to allow plural-stage shifting of the tilt angle of the liquid crystal molecule in the liquid crystal dimming device. Thus, a speed of response of the liquid crystal molecule in the state transition is increased while suppressing instability in changing the transmitted light amount which would occur in a state transition as mentioned above (this phenomenon will be referred to as a “bounding phenomenon” hereinafter in this specification).

According to the liquid crystal dimmer, the image pickup unit, and the method of driving a liquid crystal dimming device according to the embodiments of the present disclosure, since when the liquid crystal dimming device is caused to undergo the state transition from one dimmed state to another dimmed state, these dimmed states being different from each other in transmitted light amount, the drive voltage is controlled to allow plural-stage shifting of the tilt angle of the liquid crystal molecule in the liquid crystal dimming device, it is allowed to increase the speed of response of the liquid crystal molecule while suppressing instability in changing the transmitted light amount (occurrence of the bounding phenomenon). Thus, appropriate driving of the liquid crystal dimming device is allowed.

It is to be understood that both the foregoing general description and the following detailed description are exemplary, and are intended to provide further explanation of the technology as claimed.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the technology.

FIG. 1 is a block diagram illustrating a schematic configuration example of an image pickup unit according to an embodiment of the present disclosure.

FIG. 2 is a sectional diagram illustrating a configuration example of a liquid crystal dimming device illustrated in FIG. 1.

FIG. 3A and FIG. 3B are timing waveform diagrams each illustrating one example of a waveform (a drive waveform) of a drive voltage.

FIG. 4 is a schematic diagram illustrating one example of a relation between a drive voltage and a light transmittance of incident light in the liquid crystal dimming device illustrated in FIG. 2.

FIG. 5A and FIG. 5B are schematic diagrams respectively illustrating examples of a light transmitted state and a light shielded state of the liquid crystal dimming device illustrated in FIG. 2.

FIG. 6A, FIG. 6B, and FIG. 6C are schematic diagrams for explaining an example of a state transition of a dimmed state in the liquid crystal dimming device illustrated in FIG. 2.

FIG. 7 is a schematic diagram illustrating examples of a driving operation of a liquid crystal dimming device according to a comparative example.

FIG. 8 is a timing waveform diagram illustrating an example of a state transition of a dimmed state in the driving operation illustrated in FIG. 7.

FIG. 9 is a schematic diagram illustrating examples of an operation of driving the liquid crystal dimming device according to an embodiment.

FIG. 10 is a timing waveform diagram illustrating state transitions of dimmed states in driving operations involving Examples and the comparative example.

FIG. 11 is a diagram illustrating an example of a temperature control table used in execution of the operation of driving the liquid crystal dimming device according to the embodiment.

FIG. 12A, FIG. 12B, and FIG. 12C are timing waveform diagrams each illustrating a temperature-dependent state transition example of a dimmed state when the temperature control table illustrated in FIG. 11 is used.

FIG. 13 is a schematic diagram for explaining a voltage for temperature correction applied in an initial state in the temperature control table illustrated in FIG. 11.

FIG. 14 is a schematic diagram illustrating a driving operation example for a liquid crystal dimming device according to a modification example 1.

FIG. 15 is a schematic diagram illustrating a driving operation example for a liquid crystal dimming device according to a modification example 2.

FIG. 16 is a schematic diagram illustrating a driving operation example for a liquid crystal dimming device according to a modification example 3.

### DETAILED DESCRIPTION

Next, a preferred embodiment of the present disclosure will be described in detail with reference to the accompanying drawings. It is to be noted that description will be made in the following order.

1. Embodiment (an example in which a transition from a light transmitted state to a light shielded state is made using a negative GH-type liquid crystal)

### 2. Modification Examples

Modification Example 1 (an example in which a transition from the light shielded state to the light transmitted state is made using a negative GH-type liquid crystal)

Modification Example 2 (an example in which a transition from the light shielded state to the light transmitted state is made using a positive GH-type liquid crystal)

Modification Example 3 (an example in which a transition from the light transmitted state to the light shielded state is made using a positive GH-type liquid crystal)

### 3. Other Modification Examples

### EMBODIMENT

[Configuration of Image Pickup Unit 1]

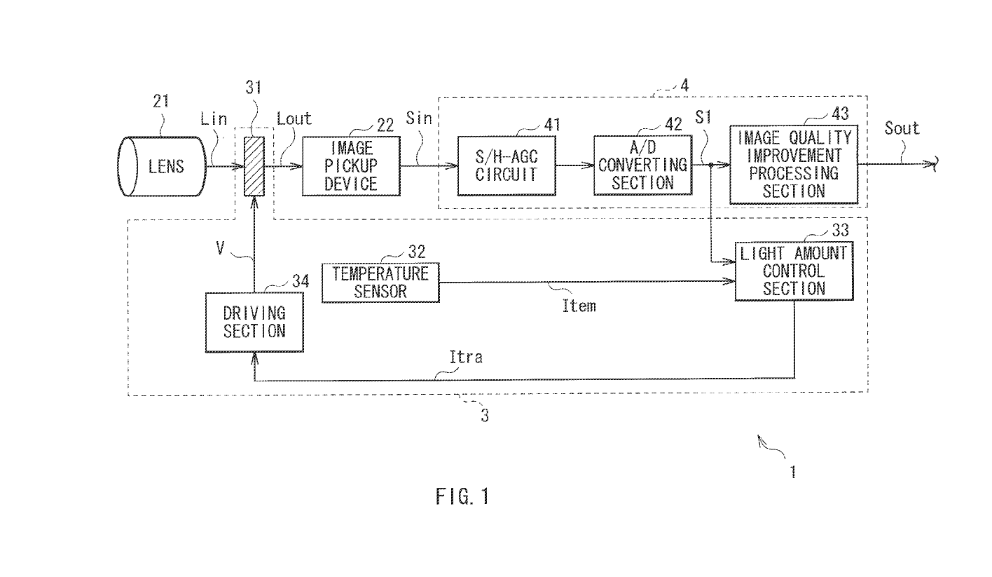

FIG. 1 is a block diagram illustrating a schematic configuration of an image pickup unit (an image pickup unit 1) according to one embodiment of the present disclosure. This image pickup unit 1 is, for example, a digital camera (a digital still camera) that converts an optical image from a subject into an electric signal by an image pickup device (a later described image pickup device 22). A picked-up image signal (a digital signal) so obtained is allowed to be recorded in a semiconductor recording medium (not illustrated) and displayed on a display (not illustrated) such as a liquid crystal display.

The image pickup unit 1 includes a lens 21, the image pickup device 22, a liquid crystal dimmer 3 that includes a later described liquid crystal dimming device 31, and a signal processing section 4. It is to be noted that since a method of driving a liquid crystal dimming device according to an embodiment of the present disclosure is embodied in the image pickup unit 1 (the liquid crystal dimmer 3) according to the present embodiment, description of the method will be made hereinbelow together with description of the image pickup unit 1. The same thing also applies to later described modification examples.

Although the lens 21 is configured using one lens herein, the lens 21 may be configured using a lens group that includes a plurality of lenses.

The image pickup device 22 detects picked-up image light (picked-up image light Lout that exits from the liquid crystal dimming device 31) that enters the device 22 from the lens 21 through the later described liquid crystal dimming device 31 to acquire an picked-up image signal Sin. The image pickup device 22 is configured by using an imaging sensor (a solid image pickup device) such as a charge-coupled device (CCD) and a complementary metal-oxide semiconductor (CMOS).

### (Signal Processing Section 4)

The signal processing section 4 performs predetermined signal processing on the picked-up image signal Sin acquired by the image pickup device 22. The image processing section 4 includes an S/H-AGC circuit 41, an A/D converting section 42, and an image quality improvement processing section 43.

The S/H-AGC circuit 41 performs S/H (sampling and holding) processes on the picked-up image signal Sin output from the image pickup device 22 and also performs a predetermined signal amplifying process using an AGC (Automatic Gain Control) function.

The A/D converting section 42 performs an A/D converting (analog-to-digital converting) process on the picked-up image signal output from the S/H-AGC circuit 41 to generate a picked-up image signal S1 that includes a digital signal.

The image quality improvement processing section 43 performs a predetermined image quality improving process on the picked-up image signal S1 (the digital signal) output from the A/D converting section 42 and outputs a picked-up image signal Sout subjected to the image quality improving process. Examples of the image quality improving process include a color correcting process, a noise reducing process, a distortion aberration correcting process, and others. It is to be noted that the picked-up image signal Sout which has been generated by being subjected to the image quality improving process is output to the outside (a not illustrated semiconductor recording medium or the like) of the signal processing section 4.

### (Liquid Crystal Dimmer 3)

The liquid crystal dimmer 3 performs an operation (a dimming operation) of adjusting the light amount of picked-up image light (picked-up image light Lin) that enters the dimmer 3 from the side of the lens 21 and includes the liquid crystal dimming device 31, a temperature sensor 32, a light amount control section 33 (a control section), and a driving section 34.

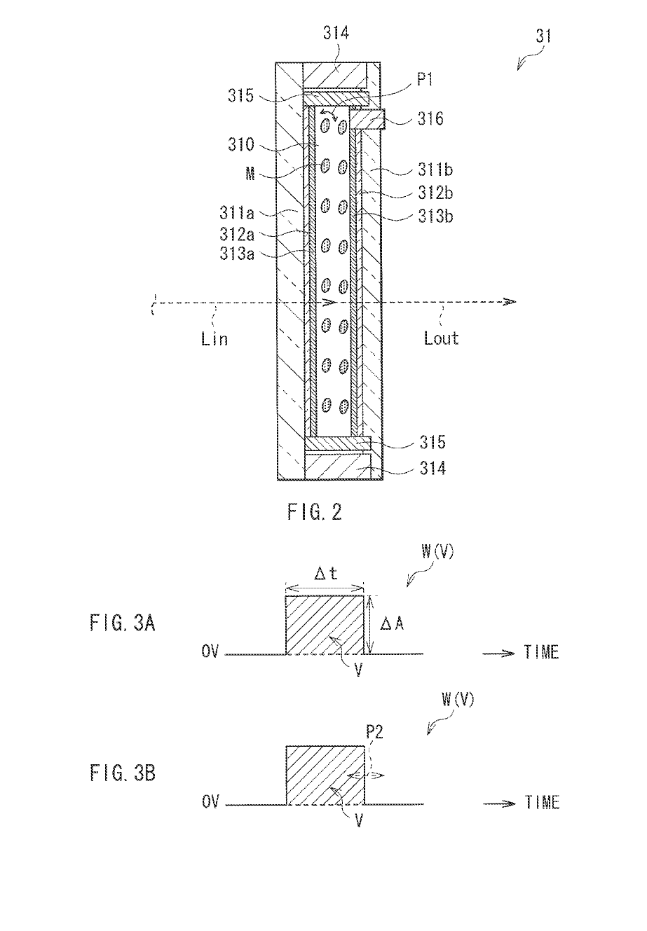

The liquid crystal dimming device 31 adjusts the light amount (the transmitted light amount) of the above mentioned picked-up image light Lin and is disposed on an optical path (on an optical path of the picked-up image light) between the lens 21 and the image pickup device 22 here. Specifically, this liquid crystal dimming device 31 electrically performs light amount adjustment (dimming) by utilizing a liquid crystal. It is to be noted that a detailed configuration of the liquid crystal dimming device 31 will be described later (FIG. 2).

The temperature sensor 32 is disposed near (in a surrounding region of) the liquid crystal dimming device 31 to detect the temperature near the liquid crystal dimming device 31. The temperature sensor 32 is configured using, for example, a thermistor. Temperature information Item indicating the detected temperature near the liquid crystal dimming device 31 is output to the light amount control section 33.

The light amount control section 33 supplies a control signal for the liquid crystal dimming device 31 to the driving section 34, to control a dimming operation (a light amount adjusting operation) of the liquid crystal dimming device 31. In other words, the light amount control section 33 controls a later described drive voltage V which is supplied from the driving section 34 to control a dimmed state of the liquid crystal dimming device 31. Here, light transmittance information Itra (light amount information that indicates the light amount (the transmitted light amount, brightness) of the picked-up image light Lout (outgoing light) that exists from the liquid crystal dimming device 22) that indicates the light transmittance of the picked-up image light Lin (the incident light) into the liquid crystal dimming device 31 is used as the control signal for the liquid crystal dimming device 31.

Specifically, the light amount control section 33 detects a signal value of the picked-up image signal S1 output from the A/D converting section 42 and sets the light transmittance information Itra (the light amount information) based on that signal value (a wave-detected value). Specifically, the light amount control section 33 determines the light amount (the transmitted light amount) of the picked-up image light Lout that exits from the liquid crystal dimming device 31 based on the signal value of the picked-up image signal S1 and outputs the information Itra on that light amount. In addition, the light amount control section 33 also has a function of performing predetermined temperature control (temperature correction of the transmitted light amount) utilizing the temperature information Item output from the temperature sensor 32, by using data (for example, a later described temperature control table LT) which is held in advance in a not illustrated storage section (a memory).

Here, in the light amount control section 33 according to the present embodiment, the drive voltage V is controlled so as to allow plural-stage shifting of a tilt angle (a later described tilt angle θ) of a later described liquid crystal molecule in the liquid crystal dimming device 31, when the liquid crystal dimming device 31 is caused to undergo a state transition between dimmed states which are different from each other in transmitted light amount. Specifically, in the present embodiment, the control of the drive voltage V is performed when a state transition from one dimmed state (a relatively bright state in which the transmitted light amount is relatively large; for example, the light transmitted state) to another dimmed state (a relatively dark state in which the transmitted light amount is relatively small; for example, the light shielded state) is made. To be more specific, when the state transition is to be made by setting one dimmed state as mentioned above as an initial state and another dimmed state as mentioned above as a target state, control is performed such that the tilt angle θ is shifted from a value in the initial state to a value in the target state through the plurality of stages (here, for example, two stages). In other words, an initial control step in which a state transition from one dimmed state mentioned above to a first-stage state is made and a final control step in which a state transition from the first stage state to states of second and succeeding stages (another dimmed state mentioned above is also included) is made are included in the above state transition. It is to be noted that details of such an operation (an operation of driving the liquid crystal dimming device 31) of controlling the drive voltage V as mentioned above which is performed by the light amount control section 33 will be described later.

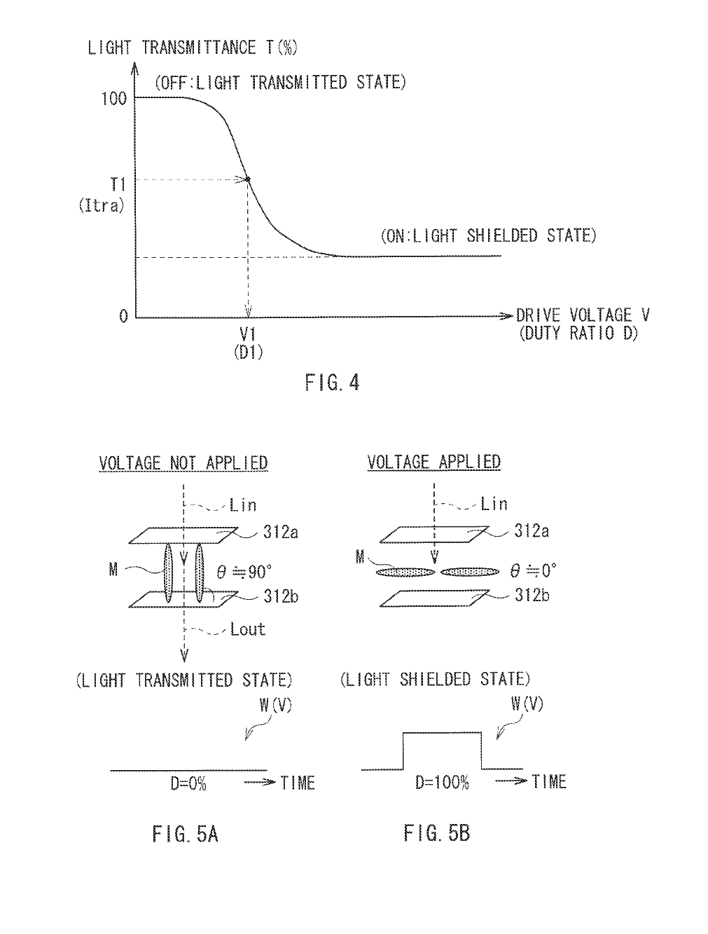

The driving section 34 performs the operation of driving the liquid crystal dimming device 31 based on the light transmittance information Itra (the light amount information) which is supplied from the light amount control section 33. Specifically, the driving section 34 determines the drive voltage V for the liquid crystal dimming device 31 based on the light transmittance information Itra described above and supplies the drive voltage V to the liquid crystal dimming device 31 (between later described transparent electrodes 221a and 221b to perform the driving operation. It is to be noted that a detailed configuration (a drive waveform) of this drive voltage V and details of a technique of determining the drive voltage V will be respectively described later (FIGS. 3A and 3B and FIG. 4).

### [Detailed Configuration Example of Liquid Crystal Dimming Device 31]

FIG. 2 schematically illustrates a sectional configuration example of the liquid crystal dimming device 31. The liquid crystal dimming device 31 has a layered structure in which a transparent substrate 311a, a transparent electrode 312a, an orientation film 313a, a liquid crystal layer 310, an orientation film 313b, a transparent electrode 312b, and a transparent substrate 311b are stacked in this order from the side on which the picked-up image light Lin is incident to the side from which the picked-up image light Lout exits. The liquid crystal dimming device 31 also includes a sealing agent 314, a spacer 315, and a sealing section 316.

The liquid crystal layer 310 contains liquid crystal molecules and also contains molecules of a predetermined coloring matter (molecules of, for example, a dichromatic dye) in addition to the liquid crystal molecules here (although the liquid crystal molecules and the coloring matter molecules are generally referred to as “a molecule or molecules M” for simplification of illustration in FIG. 2, in the following, these molecules will be also generally referred to as “a liquid crystal molecule or molecules M” as the case may be for the convenience of explanation). In other words, the liquid crystal dimming device 31 is configured using a guest-host (GH) type liquid crystal that contains a coloring matter (for example, a dichromatic coloring matter).

A liquid crystal of the GH type (a GH type liquid crystal) as mentioned above is roughly classified into a negative type one and a positive type one depending on a difference in orientation between longitudinal directions of the molecules of these liquid crystals when a voltage is applied. The positive GH type liquid crystal is of the type that the longitudinal direction of each liquid crystal molecule is perpendicular to an optical axis when the voltage is not applied (an OFF state) and the longitudinal direction of the liquid crystal molecule is parallel to the optical axis when the voltage is applied (an ON state). On the other hand, the negative GH type liquid crystal is of the type that the longitudinal direction of each liquid crystal molecule is parallel to the optical axis when the voltage is not applied and the longitudinal direction of the liquid crystal molecule is perpendicular to the optical axis when the voltage is applied. Here, since each molecule of the coloring matter is oriented in the same direction (orientation) as the liquid crystal molecule, when the positive type liquid crystal is used as a host, the light transmittance thereof is relatively low (the light exiting side gets relatively dark) when the voltage is not applied, and the light transmittance is relatively high (the light exiting side gets relatively bright) when the voltage is applied. On the other hand, when the negative type liquid crystal is used as the host, the light transmittance thereof is relatively high (the light exiting side gets relatively bright) when the voltage is not applied, and the light transmittance is relatively low (the light exiting side gets relatively dark) when the voltage is applied. It is to be noted that in the present embodiment (and a later described modification example 1), description will be made by giving a case in which the liquid crystal layer 310 contains the negative type liquid crystal as an example, and in later described modification examples 2 and 3, description will be made by giving a case in which the liquid crystal layer 310 contains the positive type liquid crystal as an example.

Each of the transparent electrodes 312a and 312b is adapted to apply a voltage (the drive voltage V) to the liquid crystal layer 310 and is made of, for example, indium tin oxide (ITO). It is to be noted that wiring (not illustrated) to be electrically connected with the transparent electrodes 312a and 312b may be appropriately arranged.

Each of the orientation films 313a and 313b is adapted to orient each liquid crystal molecule in the liquid crystal layer 310 in a desired direction (an oriented direction). Each of the orientation films 313a and 313b is made of a polymer material such as polyimide and the oriented direction of each liquid crystal molecule is set by performing a rubbing process on each orientation film in advance in a predetermined direction.

The transparent substrate 311a is disposed on one side so as to support the transparent electrode 312a and the orientation film 313a and to seal the liquid crystal layer 310. The transparent substrate 311b is disposed on the other side so as to support the transparent electrode 312b and the orientation film 313b and to seal the liquid crystal layer 310. Each of the transparent substrates 311a and 311b is formed by, for example, a glass substrate.

The sealing agent 314 is a member with which the both side-surface sides of the liquid crystal layer 310 are filled to seal the molecules M (the liquid crystal molecules and the coloring matter molecules) in the liquid crystal layer 310 and is made of an adhesive such as an epoxy adhesive and an acrylic adhesive. The spacer 315 is a member adapted to maintain a cell gap (the thickness) of the liquid crystal layer 310 constant and is made of, for example, a predetermined resin material or glass material. The sealing section 316 serves as a sealing port through which the molecules M are filled in the liquid crystal layer 310 and then serves as a part that seals the molecules M in the liquid crystal layer 310 from the outside.

### [Functions and Effects of Image Pickup Unit 1]

### (1. Image Picking-Up Operation)

In the image pickup unit 1, the picked-up image light Lin that has exited from the lens 21 enters the liquid crystal dimming device 31 in which its light amount (the transmitted light amount) is then adjusted, and the light thus adjusted exits as the picked-up image light Lout. The picked-up image light Lout enters the image pickup device 22 and is detected, by which the picked-up image signal Sin is obtained as illustrated in FIG. 1.

In the above mentioned case, in the liquid crystal dimming device 31, the picked-up image light Lin (incident light) passes (transmits) through the liquid crystal layer 310 and the like and exits as the picked-up image light Lout (outgoing light) as illustrated in FIG. 2. When a predetermined voltage (the drive voltage V) is applied between the transparent electrodes 312a and 312b in the above mentioned situation, the oriented direction (the longitudinal direction) of each of the molecules M (the liquid crystal molecules and the coloring matter molecules) in the liquid crystal layer 310 is changed and the light amount (the transmitted light amount) of the picked-up image light Lout that passes through the liquid crystal layer 310 is also changed accordingly. In other words, the light transmittance of the incident picked-up image light Lin is changed. Therefore, it is allowed to electrically (not mechanically) adjust the light amount (the light transmittance of the picked-up image light Lin) of the picked-up image light Lout that passes wholly through the liquid crystal dimming device 31 (it is allowed to perform an optional dimming operation) by adjusting the drive voltage V which is to be applied at that time. Specifically, for example, when the surrounding environment is bright, the transmitted light amount is adjusted to be decreased (the light gets dark), while when the surrounding environment is dark, the transmitted light amount is adjusted to be increased (the light gets bright). The light amount of the picked-up image light is adjusted (dimmed) by the liquid crystal dimming device 31 in the above mentioned manner.

Here, it is assumed that the drive voltage V to be applied to the liquid crystal dimming device 31 includes a drive waveform W (V) having an amplitude AA and a pulse width Δt, that is, for example, a rectangular waveform, for example, as illustrated in FIG. 3A. In the above mentioned situation, a value (an integrated value of a shaded portion in the drawing) which is a multiplied value (the amplitude ΔA×the pulse width Δt) of the amplitude and the pulse width corresponds to the drive voltage V. In addition, in the present embodiment, the value of the drive voltage V is controlled by changing (modulating) the pulse width Δt of the drive waveform W (V), for example, as illustrated in FIG. 3B. In other words, the driving section 34 is configured to supply the drive voltage V with Pulse Width Modulation (PWM).

Here, FIG. 4 schematically illustrates one example of a relation between the drive voltage V which is applied to the liquid crystal dimming device 31 and the transmittance (light transmittance T) of the image picked-up light Lin which is input into the liquid crystal dimming device 31. In this example, the negative GH type liquid crystal is used in the liquid crystal layer 310 and the light amount (the transmitted light amount) of the picked-up image light Lout which is obtained in a voltage-not-applied state (the OFF state) is set as a reference (100%). It is seen from the example in FIG. 4 that a shielded light amount is greatly increased (the light transmittance T is greatly decreased) in the liquid crystal layer 310 as the drive voltage V is increased and then is settled to an almost constant value (the ON state). Values, a gradient, and a dimmed range obtained when the light transmittance T is changed in the liquid crystal dimming device 31 as mentioned manner are changed respectively depending on the material and the concentration of the liquid crystal layer 310 (the liquid crystal and the coloring matter), the cell gap (the thickness) of the liquid crystal layer 310, the kind (the material) of the orientation films 313a and 313b, and the like. It is to be noted that when the positive GH type liquid crystal is used in the liquid crystal layer 310, such a tendency is observed that the transmittance is low in the voltage-not-applied state and the light transmittance T is increased with increasing the drive voltage V, differently from the characteristics illustrated in FIG. 4.

Next, the signal processing section 4 performs predetermined signal processing on the picked-up image signal Sin which has been obtained in the above mentioned manner. Specifically, first, the S/H-AGC circuit 41 performs the sampling and holding processes on the picked-up image signal Sin and performs the predetermined signal amplifying process on the signal Sin using the AGC function. Then, the A/D converting section 42 performs the A/D converting process on the resultant signal to generate the picked-up image signal S1 that includes the digital signal. Then, the image quality improvement processing section 43 performs the predetermined image quality improving process on the picked-up image signal S1 to generate the picked-up image signal Sout subjected to the image quality improving process.

On the other hand, the light amount control section 33 in the liquid crystal dimmer 3 sets and outputs the light transmittance information Itra (the light amount information) as the control signal for the liquid crystal dimming device 31 by using the signal value (the wave-detected value) of the picked-up image signal S1 and the temperature information Item (the information on the temperature near the liquid crystal dimming device 31) output from the temperature sensor 32. Then, the driving section 34 performs a driving operation on the liquid crystal dimming device 31 based on the light transmittance information Itra supplied from this light amount control section 33. Specifically, the light amount control section 33 controls the drive voltage V supplied from the driving section 34 to control the dimmed state of the liquid crystal dimming device 31.

Specifically, the driving section 34 determines the drive voltage V for the liquid crystal dimming device 31 based on the light transmittance information Itra and supplies the drive voltage V thus determined to the liquid crystal dimming device 31 (between the transparent electrodes 311a and 311b) to perform the driving operation on the liquid crystal dimming device 31. In the above mentioned case, the driving section 34 determines the drive voltage V from the light transmittance information Itra by using a characteristic line (for example, see FIG. 4) indicating the relation between the light transmittance T and the drive voltage V of the liquid crystal dimming device 31. In the example illustrated in FIG. 4, the drive voltage V=V1 and a duty ratio D1 corresponding to that drive voltage V1 are obtained from light transmittance T1 indicated by the light transmittance information Itra.

### (2. Driving Operation on Liquid Crystal Dimming Device 31)

Here, more concrete examples of a driving operation as described above which is to be performed on the above mentioned liquid crystal dimming device 31 are as illustrated, for example, in FIG. 5A and FIG. 5B. It is to be noted that, here, description will be made by giving a case in which the liquid crystal layer 310 of the liquid crystal dimming device 31 includes the negative liquid crystal as described above as an example.

First, when the voltage is not applied (for example, the drive voltage V=about 0 V and the duty ratio D=about 0%), the longitudinal direction of each liquid crystal molecule M is parallel to the optical axis (the optical path of the picked-up image light Lin and Lout), for example, as illustrated in FIG. 5A. An angle at which the liquid crystal molecule M tilts in the thickness direction (the intra-layer direction) of the liquid crystal layer 310 with the intra-layer direction of the liquid crystal layer 310 as a reference is defined as a tilt angle (a slant angle, a rotation angle) θ in the following. In this state, the tilt angle θ is nearly equal to 90 degrees when the voltage is not applied as mentioned above. When the liquid crystal molecule M is oriented at a tilt angle θ as mentioned above, the light transmittance T of the picked-up image light Lin is relatively high (the transmitted light amount of the picked-up image light Lout is relatively high and the light gets bright) and, for example, a light transmitted state is obtained.

On the other hand, when the voltage is applied (for example, the drive voltage V=Vmax (a maximum voltage) and the duty ratio D=about 100%), the longitudinal direction of the liquid crystal molecule M is perpendicular to the optical axis (the optical path of the picked-up image light Lin and Lout), for example, as illustrated in FIG. 5B. In other words, the tilt angle θ is nearly equal to zero degrees when the voltage is applied as mentioned above. When the liquid crystal molecule M is oriented at such a tilt angle θ, the light transmittance T of the picked-up image light Lin is relatively low (the transmitted light amount of the image pickup light Lout is relatively low and the light gets dark) and, for example, a light shielded state is obtained.

### (Response Speed of Liquid Crystal Molecules)

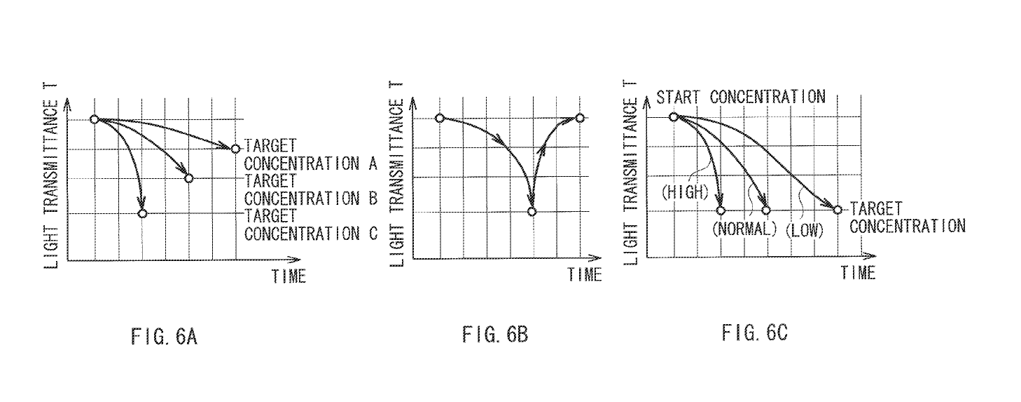

Incidentally, the dimmed state of the above mentioned liquid crystal dimming device 31 generally exhibits a state transition, for example, as illustrated in FIG. 6A to FIG. 6C. Specifically, a different response curve (a curve indicating a time-dependent change in the light transmittance T) is obtained for a different combination of a start state (the initial state) with the target state in the state transition, for example, as illustrated in FIG. 6A. In addition, even if the same value (concentration) of the light transmittance T is obtained in two dimmed states, response curves thereof differ from each other due to a difference in direction of the state transition between these two states, for example, as illustrated in FIG. 6B. Further, even if dimmed states are the same as one another in the start state and the target state, response curves thereof greatly differ from one another depending on the temperature, for example, as illustrated in FIG. 6C.

It may be said that it is desirable to adopt a driving method configured to cope with a fluctuation (a fluctuation in response speed of the liquid crystal molecule) in response curve characteristics of the liquid crystal, thereby promoting improvement of the response speed, for reasons as mentioned above. However, when a driving technique such as overdrive which is generally used as a method of driving a liquid crystal device of a liquid crystal display is adopted, the driving method may be complicated.

### (Driving Operation of Comparative Example)

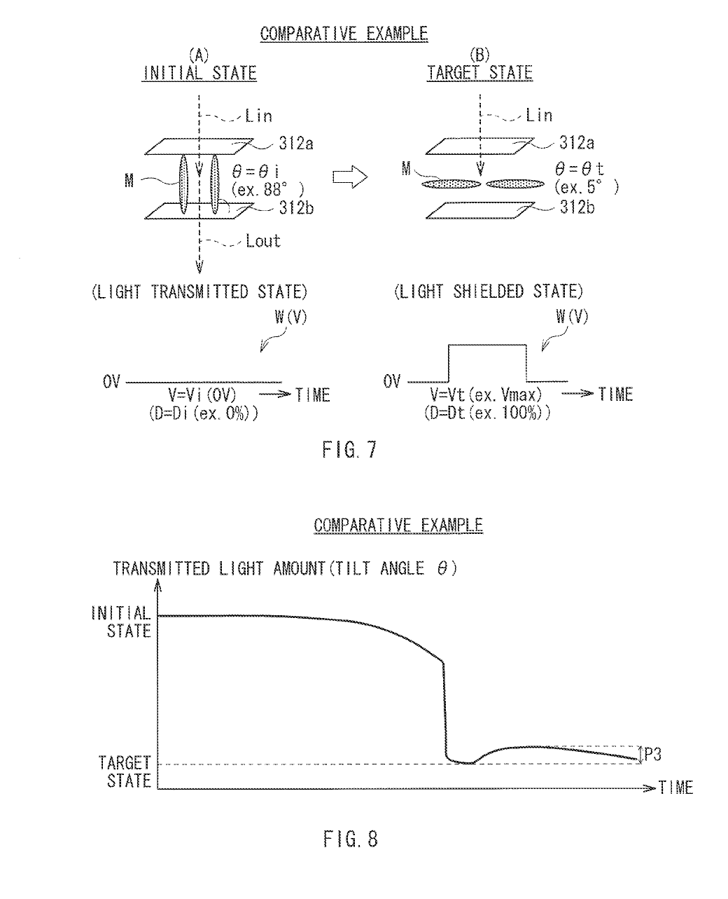

Here, in a comparative example illustrated in (A) and (B) of FIG. 7, a driving operation as described hereinbelow is performed when the state transition (the state transition in which the tilt angle θ of each liquid crystal molecule M is decreased) is made from the light transmitted state (the initial state) to the light shielded state (the target state) in the above mentioned examples illustrated in FIG. 5A and FIG. 5B.

First, in the initial state illustrated in (A) of FIG. 7, for example, a voltage is applied (for example, a drive voltage V1=about 0 V and a duty ratio Di=about 0%), and the longitudinal direction of each liquid crystal molecule M is parallel to the optical axis. Specifically, a tilt angle θi of the liquid crystal molecule M is nearly equal to 90 degrees (for example, about 88 degrees) in the initial state. The light transmittance T of the picked-up image light Lin is relatively high (the transmitted light amount of the picked-up image light Lout is relatively high and the light gets bright) and, for example, the light transmitted state is obtained.

Next, in the target state illustrated in (B) of FIG. 7, for example, a voltage is applied (for example, a drive voltage Vt=Vmax (a maximum voltage) and a duty ratio Dt=about 100%), and the longitudinal direction of the liquid crystal molecule M is perpendicular to the optical axis. Specifically, a tilt angle θt of the liquid crystal molecule M is nearly equal to zero degrees (for example, about 5 degrees) in the target state. The light transmittance T of the picked-up image light Lin is relatively low (the transmitted light amount of the picked-up image light Lout is relatively low and the light gets dark) and, for example, the light shielded state is obtained.

However, in the driving operation in the above mentioned comparative example, in the state transition from the initial state to the target state, the tilt angle θ of the liquid crystal molecule M is shifted only at one stage (θi→θt). In other words, the drive voltage V and its duty ratio D are also shifted only at one stage (Vi→Vt and Di→Dt). Specifically, the driving operation is performed such that the state transition from the initial state (the start state) to the target state is made at a time (at a stretch). Thus, in the driving operation in the comparative example, for example, as indicated by a symbol P3 in FIG. 8, instability (a so-called bounding phenomenon) occurs in changing the transmitted light amount (the tilt angle θ) in the state transition and hence such a long time as about several ten seconds may be taken until the light amount is stabilized in some cases.

It is to be noted that although multi-stage drive which is used, for example, in a TV (television) set or the like may be given as one of techniques of suppressing occurrence of the bounding phenomenon, a driving method may become greatly complicated in the multi-stage drive. In addition, in a portable unit such as an image pickup unit, power used for control is limited and hence adoption of the multi-stage drive may not be practical.

### (Driving Operation of Embodiment)

Therefore, in the present embodiment, a driving operation which will be described in detail hereinbelow is performed on the liquid crystal dimming device 31 in the liquid crystal dimmer 3. Specifically, the light amount control section 33 controls the drive voltage V so as to allow plural-stage (here, two-stage) shifting of the tilt angle θ of the liquid crystal molecule M in the liquid crystal dimming device 31 when the liquid crystal dimming device 31 is caused to undergo a state transition between dimmed states which are different from each other in transmitted light amount.

### (A. Basic Operations)

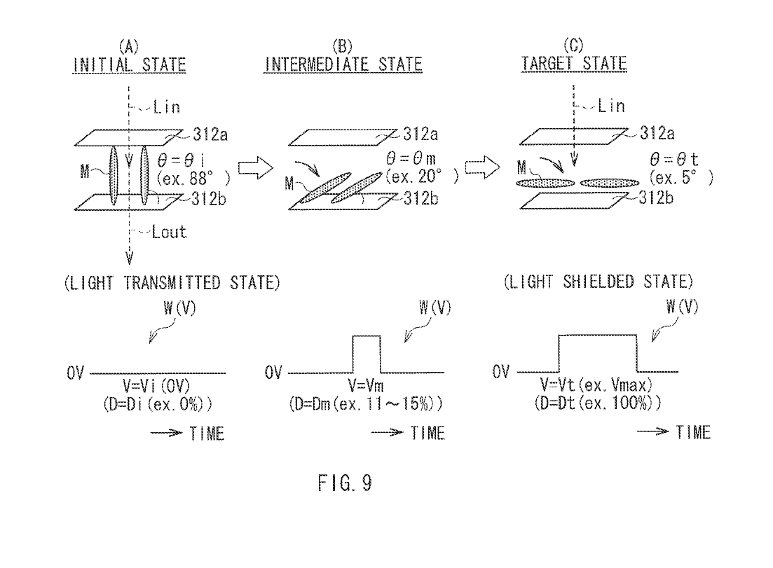

Specifically, first, the light amount control section 33 controls the drive voltage V so as to allow stepwise shifting of the tilt angle θ with one stage or a plurality of stages (here, one stage) of intermediate state(s) included between the initial state and the target state, for example, as illustrated in (A) to (C) of FIG. 9. To be more specific, the tilt angle θ of the liquid crystal molecule M is shifted at two stages (θi→θm→t) with the intermediate state interposed between the initial state and the target state in the state transition from the initial state to the target state in this example. In other words, the drive voltage V and its duty ratio D are also shifted at two stages (Vi→Vm→Vt and Di→Dm→Dt) in order of the initial state, the intermediate state, and the target state. Here, the tilt angle θm, the drive voltage Vm, and the duty ratio Dm in the intermediate state have values respectively between values of the tilt angle θi in the initial state and the tilt angle θt in the target state, between values of the drive voltage Vi in the initial state and the drive voltage Vt in the target state, and between values of the duty ratio Di in the initial state and the duty ratio Dt in the target state. In other words, in this example, relations θi>θm>θt, Vi<Vm<Vt, and Di<Dm<Dt are established.

More specifically explaining this driving operation, first, in the initial state illustrated in (A) of FIG. 9, for example, the voltage is not applied (for example, the drive voltage Vi=about 0 V and the duty ratio Di=about 0%), and the longitudinal direction of each liquid crystal molecule M is parallel to the optical axis. Specifically, the tilt angle θi of the liquid crystal molecule M is nearly equal to 90 degrees (for example, about 88 degrees) in the initial state. The light transmittance T of the picked-up image light Lin is relatively high (the transmitted light amount of the picked-up image light Lout is relatively high and the light gets bright) and, for example, the light transmitted state is obtained.

Next, in the intermediate state illustrated in (B) of FIG. 9, a voltage applied state (the drive voltage Vm and the duty ratio Dm (for example, about 11% to about 15% both inclusive)) indicating the above mentioned relations in magnitude is exhibited. Thus, in the intermediate state, the tilt angle θm of the liquid crystal molecule M has a value (for example, about 20 degrees) that indicates the above mentioned relation in magnitude and the light transmittance T of the picked-up image light Lin has an intermediate-state value (the transmitted light amount of the picked-up image light Lout has an intermediate-state value).

Next, in the target state illustrated in (C) of FIG. 9, for example, the voltage is applied (for example, the drive voltage Vt=Vmax and the duty ratio Dt=about 100%), and the longitudinal direction of the liquid crystal molecule M is perpendicular to the optical axis. Specifically, the tilt angle θt is nearly equal to zero degrees (for example, about 5 degrees) in the target state. The light transmittance T of the picked-up image light Lin is relatively low (the transmitted light amount of the picked-up image light Lout is relatively low and the light gets dark) and, for example, the light shielded state is obtained.

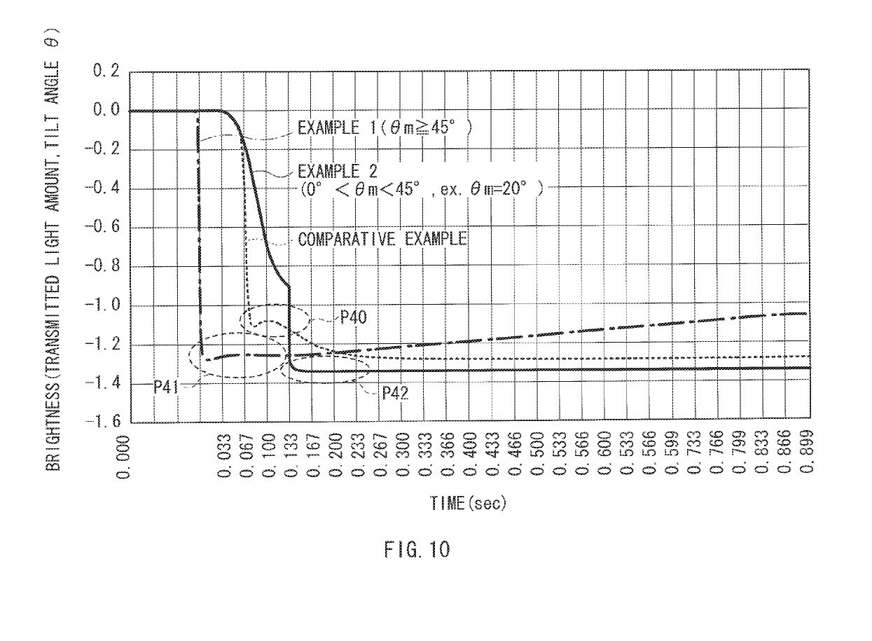

Instability (occurrence of the bounding phenomenon) in changing the transmitted light amount (the tilt angle θ) in the state transition is suppressed by performing the driving operation, for example, as indicated in Examples 1 and 2 in FIG. 10 as compared with the above mentioned comparative example. Specifically, a large-scale bounding phenomenon occurs in the comparative example as indicated by a symbol P40 in FIG. 10. On the other hand, occurrence of the bounding phenomenon is reduced or avoided in the Examples 1 and 2 as respectively indicated by symbols P41 and P42. In addition, since occurrence of the bounding phenomenon as mentioned above is suppressed, the response speed of the liquid crystal molecule M in the state transition is increased as compared with the above mentioned comparative example.

Here, it is desirable that the tilt angle θm of the liquid crystal molecule M in the intermediate state have a value between (|θt−θi|/2) and θt. Specifically, in this example, it is desirable that a relation (|θi−θt|/2)>θm>θt be established. More specifically, assuming that, for example, θi=about 90 degrees and θt=about zero degrees, it is desirable that a relation about zero degrees<θm<about 45 degrees be obtained as indicated in the Example 2 in FIG. 10. In addition, in this example, it is more desirable that θm=about 20 degrees±5 degrees (the transmitted light amount=about 15% to about 20% both inclusive) be obtained. This is because in the Example 2 (about zero degrees<θm<about 45 degrees), occurrence of the bounding phenomenon is more suppressed (here, occurrence of the bounding phenomenon is avoided) than in the Example 1 (θm≧about 45 degrees), for example, as respectively indicated by the symbols P41 and P42 in FIG. 10. In addition, since occurrence of the bounding phenomenon is further suppressed as described above, it may be said that the response speed of the liquid crystal molecule M in the state transition is further increased accordingly.

### (B. Temperature Controlling Operation)

In addition, in the present embodiment, the light amount control section 33 performs a temperature controlling operation (an operation of controlling the drive voltage V depending on the temperature (the temperature information Item) near the liquid crystal dimming device 31) which will be described hereinbelow.

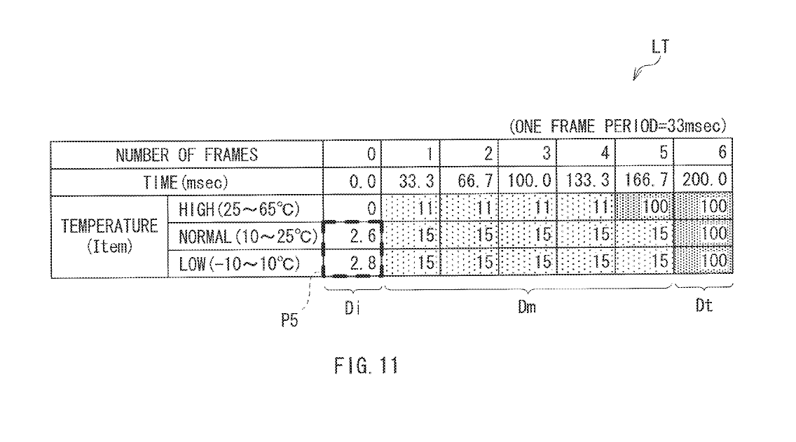

First, the light amount control section 33 acquires the temperature information Item which is supplied from the temperature sensor 32. Then, the light amount control section 33 performs the above mentioned temperature controlling operation using such a temperature control table (Look up Table) LT as that, for example, illustrated in FIG. 11. The temperature control table LT is of the type that the temperature (the temperature information Item) near the liquid crystal dimming device 31, values of the duty ratios Di, Dm, and Dt in the initial state, the intermediate state, and the target state, and the period of the intermediate state (the intermediate state period ΔTm) are made in correspondence with one another in advance. It is to be noted that in the example illustrated in FIG. 11, it is assumed that one frame period (an image pickup frame period) is about 33 milliseconds.

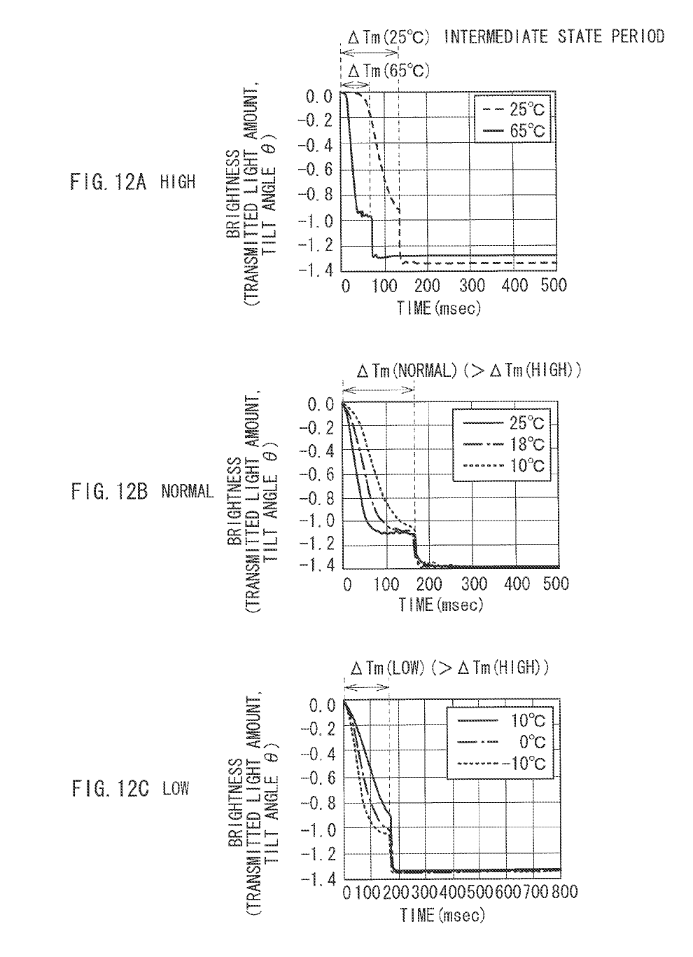

The light amount control section 33 changes the period of the intermediate state (the intermediate state period ΔTm) depending on the temperature (the temperature information Item) near the liquid crystal dimming device 31 by using the temperature control table LT, for example, as illustrated in FIG. 11. Specifically, the light amount control section 33 controls such that the intermediate state period ΔTm is relatively elongated with decreasing the temperature near the liquid crystal dimming device 31, for example, as illustrated in FIG. 11, and FIG. 12A to FIG. 12C respectively. In this example, the intermediate state periods ΔTm at normal temperatures (about 10° C. to about 25° C. both inclusive) and at low temperatures (about −0° C. to about 10° C. both inclusive) are set to be longer than the intermediate state period ΔTm at high temperatures (about 25° C. to about 65° C. both inclusive). It is allowed to readily implement the temperature controlling operation for the drive voltage V in all temperature ranges by changing the length of the intermediate state period ΔTm depending on the temperature near the liquid crystal dimming device 31 by using the temperature control table LT in the above mentioned manner.

The light amount control section 33 further controls such that a voltage (a voltage for temperature correction) used to correct the tilt angle θi of the liquid crystal molecule M in the initial state depending on the temperature near the liquid crystal diming device 31 is superimposed on the drive voltage V in this initial state, for example, as indicated by a symbol P5 in FIG. 11. In other words, the value of the duty ratio Di in this initial state is changed depending on the temperature near the liquid crystal dimming device 31. It is to be noted that such temperature control is also performed using the above mentioned temperature control table LT.

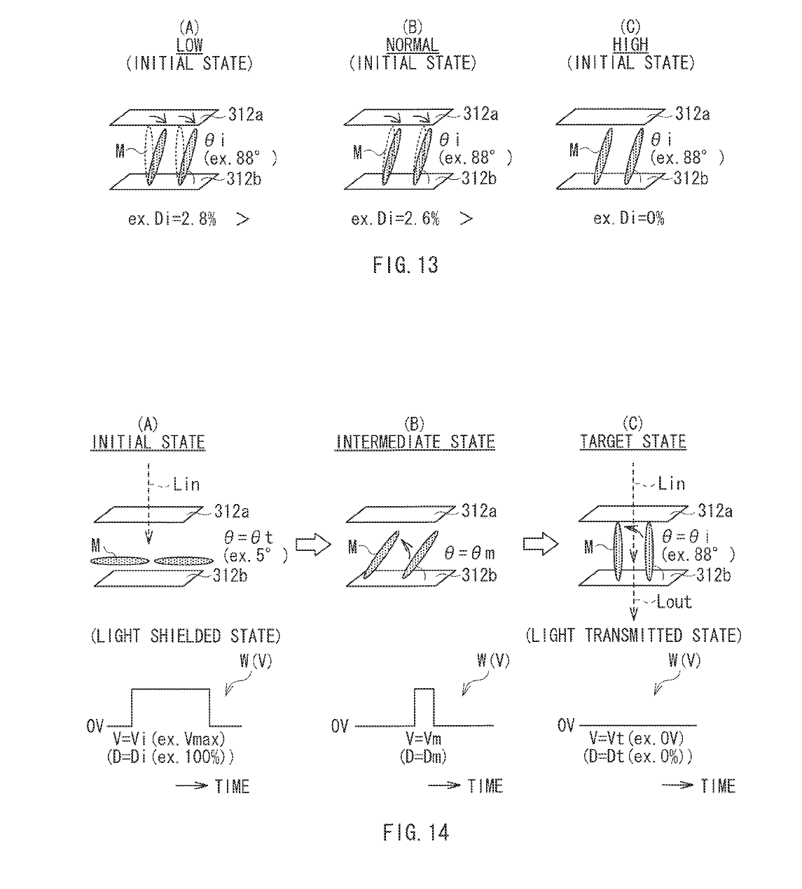

The reason why the voltage for temperature correction is superimposed on the drive voltage V in the initial state (the duty ratio Di in the initial state is changed depending on the temperature) in the above mentioned manner is as follows. That is, for example, as illustrated in (A) to (C) of FIG. 13, the liquid crystal molecule M in the initial state has such a tendency that its tilt angle θi is decreased with increasing the temperature and is increased with decreasing the temperature. Specifically, it has a relation the tilt angle θi at high temperatures (θi=about 86 degrees, for example, at a temperature around 70° C.)<the tilt angle θi at normal temperatures<the tilt angle θi at low temperatures (θi=about 90 degrees, for example, at a temperature around 0° C.). Therefore, a more time is taken for response of the liquid crystal molecule M (shifting of the tilt angle θi) on the low-temperature side where the value of the tilt angle θi more reaches the optical axis in a parallel direction than on the high-temperature side unless some measures are taken. For reasons as mentioned above, the light amount control section 33 controls the voltage for temperature correction to be superimposed on the drive voltage V in the initial state (to change the duty ratio Di in the initial state depending on the temperature) as described above.

Specifically, the light amount control section 33 controls the above mentioned voltage for temperature correction (controls the duty ratio Di) such that the tilt angle θi in the initial state is almost fixed (is desirably fixed) not depending on the temperature near the liquid crystal dimming device 31 (see arrows in (A) to (C) of FIG. 13). In the examples illustrated in (A) to (C) of FIG. 13, the voltage for temperature correction is controlled such that the tilt angle θi is fixed to, for example, about 88 degrees (a value of the tilt angle θi which is originally set, for example, at a normal temperature of about 25° C.) not depending on the temperature near the liquid crystal dimming device 31 (at low, normal, and high temperatures). More specifically, the light amount control section 33 controls the voltage for temperature correction to be relatively increased (the duty ratio Di is relatively increased) with decreasing the temperature near the liquid crystal dimming device 31. In this example, the duty ratio Di is set to have a relation the duty ratio Di (=about 0%) at high temperatures<the duty ratio Di (=about 2.6%) at normal temperatures<the duty ratio Di (=about 2.8%) at low temperatures.

In the present embodiment, the drive voltage V is controlled so as to allow plural-stage shifting of the tilt angle θ of the liquid crystal molecule M in the liquid crystal dimming device 31 when the liquid crystal dimming device 31 is caused to undergo the state transition from one dimmed state to another dimmed state, these dimmed state being different from each other in transmitted light amount, as described above. Thus, it is allowed to increase the response speed of the liquid crystal molecule M while suppressing instability (occurrence of the bounding phenomenon) in changing the transmitted light amount in a state transition as mentioned above. It is allowed to stably attain the transmitted light amount in the target state within about one second even at such a low temperature as, for example, about −10° C. or less. Thus, appropriate driving of the liquid crystal dimming device 31 is allowed.

In addition, it is also allowed to implement a driving operation which is simpler than the above mentioned overdrive, multi-stage drive, and the like.

Further, since the controlling operation (the temperature controlling operation) for the drive voltage V according to the temperature (the temperature information Item) near the liquid crystal dimming device 31 is performed, it is also allowed to reduce the fluctuation (a shift in light amount) in transmitted light amount caused by the change in temperature as mentioned above.

In addition, in the present embodiment, the above mentioned control of the drive voltage V is performed particularly but not limitatively in a state transition from one dimmed state (the relatively bright state in which the transmitted light amount is relatively large; for example, the light transmitted state) to another dimmed state (the relatively dark state in which the transmitted light amount is relatively small; for example, the light shielded state). In other words, the light amount control section 33 controls the drive voltage V so as to allow plural-stage shifting of the tilt angle θ in a state transition in which the tilt angle θ of the liquid crystal molecule M is decreased in state transitions from one dimmed state to another dimmed state. Thus, suppression of instability (occurrence of the bounding phenomenon) in changing the transmitted light amount and increasing of the response speed of the liquid crystal molecule M are attained as advantages in the present embodiment as in a later described modification example 3.

### MODIFICATION EXAMPLES

Next, modification examples (modification examples 1 to 3) of the above mentioned embodiment will be described. It is to be noted that the same numerals are assigned to the same constitutional elements as those in the above mentioned embodiment and description thereof will be appropriately omitted.

### Modification Example 1

(A) to (C) of FIG. 14 schematically illustrate driving operation examples of the liquid crystal dimming device 31 according to the modification example 1. In the modification example 1, the liquid crystal layer 310 of the liquid crystal dimming device 31 includes the negative liquid crystal as in the above mentioned embodiment. However, the light amount control section 33 performs control to allow plural-stage (here two-stage) shifting of the tilt angle θ in a state transition in which the tilt angle θ of the liquid crystal molecule M is increased, differently from the state transition in the above mentioned embodiment. The control as mentioned above is performed in the state transition from one dimmed state (the relatively dark state in which the transmitted light amount is relatively small; for example, the light shielded state) to another dimmed state (the relatively bright state in which the transmitted light amount is relatively large; for example, the light transmitted state).

In the modification example 1, first, in the initial state, for example, illustrated in (A) of FIG. 14, for example, the voltage is applied (for example, the drive voltage Vi=Vmax (a maximum voltage) and the duty ratio Di=about 100%), and the longitudinal direction of each liquid crystal molecule M is perpendicular to the optical axis. Specifically, the tilt angle θi of the liquid crystal molecule M is nearly equal to zero degrees (for example, about 5 degrees) in this initial state. The light transmittance T of the picked-up image light Lin is relatively low (the transmitted light amount of the picked-up image light Lout is relatively low and the light gets dark) and, for example, the light shielded state is obtained.

On the other hand, in the target state, for example, illustrated in (C) of FIG. 14, for example, the voltage is applied (for example, the drive voltage Vt=about 0 V and the duty ratio Dt=about 0%), and the longitudinal direction of the liquid crystal molecule M is parallel to the optical axis. Specifically, the tilt angle θt is nearly equal to 90 degrees (for example, about 88 degrees) in the target state. The light transmittance T of the picked-up image light Lin is relatively high (the transmitted light amount of the picked-up image light Lout is relatively high and the light gets bright) and, for example, the light transmitted state is obtained.

The drive voltage V is controlled so as to allow plural-stage (here, two-stage) shifting of the tilt angle θ of the liquid crystal molecule M in the liquid crystal dimming device 31 in the same manner as that in the above mentioned embodiment, for example, as illustrated in (A) to (C) of FIG. 14 also in the modification example 1 in which a state transition as mentioned above is made. Specifically, the light amount control section 33 controls the drive voltage V so as to allow stepwise shifting of the tilt angle θ with one stage or a plurality of stages (here, one stage) of intermediate state(s) included between the initial state and the target state.

Therefore, also in the modification example 1, it is allowed to obtain the same effect as that of the above mentioned embodiment by the same function as that in the above mentioned embodiment. Specifically, it is allowed to increase the response speed of the liquid crystal molecule M while suppressing instability (occurrence of the bounding phenomenon) in changing the transmitted light amount in the state transition and hence it is allowed to appropriately drive the liquid crystal dimming device 31. It is to be noted that also in the modification example 1, the operation of controlling the drive voltage V (the temperature controlling operation) according to the temperature (the temperature information Item) near the liquid crystal dimming device 31 may be performed as in the above mentioned embodiment.

### Modification Example 2

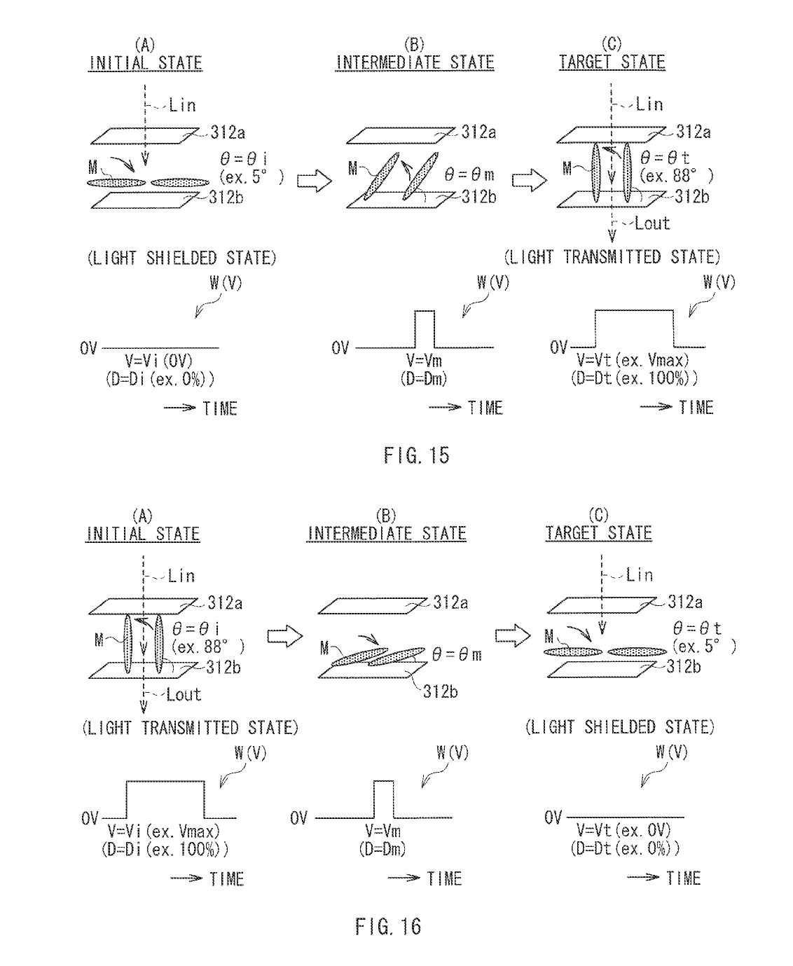

(A) to (C) of FIG. 15 schematically illustrate driving operation examples of the liquid crystal dimming device 31 according to the modification example 2. In the modification example 2, the liquid crystal layer 310 in the liquid crystal dimming device 31 includes the positive liquid crystal differently from the above mentioned embodiment and the modification example 1. In the modification example 2, the light amount control section 33 performs control so as to allow plural-stage (here, two-stage) shifting of the tilt angle θ in the state transition in which the tilt angle θ of the liquid crystal molecule M is increased as in the modification example 1. The control as mentioned above is performed in the state transition from one dimmed state (the relatively dark state in which the transmitted light amount is relatively small; for example, the light shielded state) to another dimmed state (the relatively bright state in which the transmitted light amount is relatively large; for example, the light transmitted state).

In the initial state, for example, illustrated in (A) of FIG. 15, for example, the voltage is not applied (for example, the drive voltage V1=about 0 V and the duty ratio Di=about 0%), and the longitudinal direction of the liquid crystal molecule M is perpendicular to the optical axis. Specifically, the tilt angle θi of the liquid crystal molecule M is nearly equal to 0 degrees (for example, about 5 degrees) in the initial state. The light transmittance T of the picked-up image light Lin is relatively low (the transmitted light amount of the picked-up image light Lout is relatively low and the light gets dark) and, for example, the light shielded state is obtained.

On the other hand, in the target state, for example, illustrated in (C) of FIG. 15, for example, the voltage is applied (for example, the drive voltage Vt=Vmax (a maximum voltage) and the duty ratio Dt=about 100%), and the longitudinal direction of the liquid crystal molecule M is parallel to the optical axis. Specifically, the tilt angle θt of the liquid crystal molecule M is nearly equal to 90 degrees (for example, about 88 degrees) in this target state. The light transmittance T of the picked-up image light Lin is relatively high (the transmitted light amount of the picked-up image light Lout is relatively high and the light gets bright) and, for example, the light transmitted state is obtained.

The drive voltage V is controlled so as to allow plural-stage (here, two-stage) shifting of the tilt angle θ of the liquid crystal molecule M in the liquid crystal dimming device 31 in the same manner as that in the above mentioned embodiment, for example, as illustrated in (A) to (C) of FIG. 15 also in the modification example 2 in which the state transition as mentioned above is made. Specifically, the light amount control section 33 controls the drive voltage V so as to allow stepwise shifting of the tilt angle θ with one stage or a plurality of stages (here, one stage) of intermediate state(s) included between the initial state and the target state.

Therefore, also in the modification example 2, it is allowed to obtain the same effect as that of the above mentioned embodiment by the same function as that in the above mentioned embodiment. Specifically, it is allowed to increase the response speed of the liquid crystal molecule M while suppressing instability (occurrence of the bounding phenomenon) in changing the transmitted light amount in the state transition and hence it is allowed to appropriately drive the liquid crystal dimming device 31. It is to be noted that also in the modification example 2, the operation of controlling the drive voltage V (the temperature controlling operation) according to the temperature (the temperature information Item) near the liquid crystal dimming device 31 may be performed as in the above mentioned embodiment.

### Modification Example 3

(A) to (C) of FIG. 16 schematically illustrate driving operation examples of the liquid crystal dimming device 31 according to the modification example 3. In the modification example 3, the liquid crystal layer 310 in the liquid crystal dimming device 31 includes the positive liquid crystal as in the modification example 2. However, in the modification example 3, the light amount control section 33 performs control so as to allow plural-stage (here, two-stage) shifting of the tilt angle θ in the state transition in which the tilt angle θ of the liquid crystal molecule M is decreased as in the above mentioned embodiment, differently from the modification example 2. Specifically, the control as mentioned above is performed in the state transition from one dimmed state (the relatively bright state in which the transmitted light amount is relatively large; for example, the light transmitted state) to another dimmed state (the relatively dark state in which the transmitted light amount is relatively small; for example, the light shielded state).

In the initial state, for example, illustrated in (A) of FIG. 16, for example, the voltage is applied (for example, the drive voltage Vi=Vmax (a maximum voltage) and the duty ratio Di=about 100%), and the longitudinal direction of the liquid crystal molecule M is parallel to the optical axis. Specifically, the tilt angle θi of the liquid crystal molecule M is nearly equal to 90 degrees (for example, about 88 degrees) in this initial state. The light transmittance T of the picked-up image light Lin is relatively high (the transmitted light amount of the picked-up image light Lout is relatively high and the light gets bright) and, for example, the light transmitted state is obtained.

On the other hand, in the target state, for example, illustrated in (C) of FIG. 16, for example, the voltage is not applied (for example, the drive voltage Vt=0 V and the duty ratio Dt=about 0%), and the longitudinal direction of the liquid crystal molecule M is perpendicular to the optical axis. Specifically, the tilt angle θt of the liquid crystal molecule M is nearly equal to 0 degrees (for example, about 5 degrees) in the target state. The light transmittance T of the picked-up image light Lin is relatively low (the transmitted light amount of the picked-up image light Lout is relatively low and the light gets dark) and, for example, the light shielded state is obtained.

The drive voltage V is controlled so as to allow plural-stage (here, two-stage) shifting of the tilt angle θ of the liquid crystal molecule M in the liquid crystal dimming device 31 in the same manner as that in the above mentioned embodiment, for example, as illustrated in (A) to (C) of FIG. 16 also in the modification example 3 in which the state transition as mentioned above is made. Specifically, the light amount control section 33 controls the drive voltage V so as to allow stepwise shifting of the tilt angle θ with one stage or a plurality of stages (here, one stage) of intermediate state(s) included between the initial state and the target state.

Therefore, also in the modification example 3, it is allowed to obtain the same effect as that of the above mentioned embodiment by the same function as that in the above mentioned embodiment. Specifically, it is allowed to increase the response speed of the liquid crystal molecule M while suppressing instability (occurrence of the bounding phenomenon) in changing the transmitted light amount and hence it is allowed to appropriately drive the liquid crystal dimming device 31. It is to be noted that also in the modification example 3, the operation of controlling the drive voltage V (the temperature controlling operation) according to the temperature (the temperature information Item) near the liquid crystal dimming device 31 may be performed as in the above mentioned embodiment.

### Other Modification Examples

Although the technology of the present disclosure has been described so far by giving several embodiment and modification examples, the present technology is not limited to the above mentioned embodiment and modification examples and may be modified in a variety of ways.

For example, although description has been made by giving the liquid crystal dimming device using the GH type liquid crystal as examples in the above mentioned embodiment and the like, the technology of the present disclosure is not limited to the above mentioned cases and a liquid crystal dimming device using a liquid crystal other than the GH type liquid crystal may be used.

In addition, although the methods of driving the liquid crystal dimming device have been concretely described in the above mentioned embodiment and the like, the present technology is not limited to the above mentioned driving methods. Although description has been made by giving the light transmitted state and the light shielded state as examples of the dimmed states in the initial state (one dimmed state) and the target state (another dimmed state), the dimmed states of the liquid crystal dimming device 31 in state transitions are not limited to the above mentioned states. In other words, the driving method of the present technology may be applicable not depending on these dimmed states as long as the liquid crystal dimming device 31 is caused to undergo a state transition from one dimmed state to another dimmed state, these dimmed states being different from each other in transmitted light amount. In addition, although the drive voltage V is supplied with pulse width modulation (PWM) in the above mentioned embodiment and the like, the present technology is not limited to the above and the drive voltage V may be supplied with, for example, pulse amplitude modulation (PAM) or the like. In other words, the value of the drive voltage V may be controlled by changing (modulating) the amplitude AA of the drive waveform W (V). Further, although the drive voltage V is controlled so as to allow two-stage shifting of the tilt angle θ of the liquid crystal molecule M in the liquid crystal dimming device 31 (the tilt angle θ is shifted stepwise with one stage of the intermediate state included between the initial state and the target state) in the above mentioned embodiment and the like, the present technology is not limited to the above. Specifically, the drive voltage V may be controlled such that the tilt angle θ of the liquid crystal molecule M is shifted at three or more stages (the tilt angle θ is shifted stepwise with two or more stages of intermediate states included between the initial state and the target state).

In addition, although description has been made by concretely picking up each constitutional element of the image pickup unit in the above mentioned embodiment and the like, it is permissible that the image pickup unit do not include all the constitutional elements and constitutional elements other than the above may be additionally included in the image pickup unit. For example, although description has been made by giving a case in which one lens (a lens group) is disposed in the image pickup unit (on the optical path of the picked-up image light) as an example in the above mentioned embodiment and the like, the present technology is not limited to the above. Specifically, for example, a plurality of lenses (or lens groups) may be disposed on the optical path of the picked-up image light or lenses (or lens groups) as mentioned above may not be disposed in the image pickup unit.

In addition, each signal processing (the signal processing section) and drive voltage control (the light amount control section) which have been described in the above mentioned embodiment and the like may be respectively performed by hardware (circuits) or by software (programs). When software is used to perform the above mentioned processing, the software is configured by a group of programs that makes a computer (such as, for example, a microcomputer within the image pickup unit or the like) execute each signal processing function and a function of controlling the drive voltage. Each program may be used, for example, in a state in which it is incorporated in advance into dedicated hardware or in a state in which it is installed into a general purpose personal computer over a network or from a recording medium.

It is to be noted that the present technology may be configured as follows.

(1) A liquid crystal dimmer including:

a liquid crystal dimming device adjusting a transmitted light amount of incident picked-up image light;

a driving section supplying a drive voltage for driving the liquid crystal dimming device to the liquid crystal dimming device; and

a control section controlling the drive voltage to control a dimmed state of the liquid crystal dimming device,

wherein the control section controls the drive voltage to allow plural-stage shifting of a tilt angle of a liquid crystal molecule in the liquid crystal dimming device when the liquid crystal dimming device is caused to undergo a state transition from one dimmed state to another dimmed state, the dimmed states being different from each other in the transmitted light amount.

(2) The liquid crystal dimmer according to (1), wherein

the control section controls the drive voltage to allow stepwise shifting of the tilt angle with one stage or a plurality of stages of intermediate state(s) included between an initial state as the one dimmed state and a target state as the another dimmed state.

(3) The liquid crystal dimmer according to (2), wherein

when the tilt angle in the initial state is θi, the tilt angle in the intermediate state is θm, and the tilt angle in the target state is θt, the angle θm has a value between a value of the angle θi and a value of the angle θt.

(4) The liquid crystal dimmer according to (3), wherein

the angle θm has a value between a value of (|θt−θi|/2) and the value of the angle θt.

(5) The liquid crystal dimmer according to any one of (2) to (4), wherein

the control section changes a period of the intermediate state depending on a temperature near the liquid crystal dimming device.

(6) The liquid crystal dimmer according to (5), wherein

the control section controls the period of the intermediate state to be relatively long with decreasing the temperature near the liquid crystal dimming device.

(7) The liquid crystal dimmer according to (5) or (6), wherein

the control section controls the period of the intermediate state by using a temperature control table making the temperature near the liquid crystal dimming device in correspondence with the period of the intermediate state in advance.

(8) The liquid crystal dimmer according to any one of (2) to (7), wherein

the control section controls a temperature correction voltage to be superimposed on the drive voltage in the initial state, the temperature correction voltage correcting the tilt angle in the initial state depending on the temperature near the liquid crystal dimming device.

(9) The liquid crystal dimmer according to (8), wherein

the control section controls the temperature correction voltage to almost fix the tilt angle in the initial state independently of the temperature near the liquid crystal dimming device.

(10) The liquid crystal dimmer according to (9), wherein

the control section controls the temperature correction voltage to be relatively increased with decreasing the temperature near the liquid crystal dimming device.

(11) The liquid crystal dimmer according to any one of (1) to (10), wherein

the liquid crystal dimming device includes a liquid crystal layer containing the liquid crystal molecule, and

the tilt angle is an angle that defines tilting of the liquid crystal molecule in a thickness direction of the liquid crystal layer when an intra-layer direction of the liquid crystal layer is set as a reference.

(12) The liquid crystal dimmer according to (11), wherein

the control section performs control to allow plural-stage shifting of the tilt angle in a state transition in which the tilt angle is decreased in state transitions from the one dimmed state to the another dimmed state.

(13) The liquid crystal dimmer according to any one of (1) to (12), wherein

the driving section supplies the drive voltage with pulse width modulation (PWM).

(14) An image pickup unit including:

a liquid crystal dimming device adjusting a transmitted light amount of incident picked-up image light;

an image pickup device acquiring a picked-up image signal based on picked-up image light that exits from the liquid crystal dimming device;

a driving section supplying a drive voltage for driving the liquid crystal dimming device to the liquid crystal dimming device; and

a control section controlling the drive voltage to control a dimmed state of the liquid crystal dimming device,

wherein the control section controls the drive voltage to allow plural-stage shifting of a tilt angle of a liquid crystal molecule in the liquid crystal dimming device when the liquid crystal dimming device is caused to undergo a state transition from one dimmed state to another dimmed state, the dimmed states being different from each other in the transmitted light amount.

(15) A method of driving a liquid crystal dimming device, the method including:

supplying a drive voltage to the liquid crystal dimming device to drive the liquid crystal dimming device, the liquid crystal dimming device adjusting a transmitted light amount of incident picked-up image light; and

causing the liquid crystal dimming device to undergo a state transition from one dimmed state to another dimmed state, the dimmed states being different from each other in the transmitted light amount, while controlling the drive voltage to allow plural-stage shifting of a tilt angle of a liquid crystal molecule in the liquid crystal dimming device.

The disclosure contains subject matter related to that disclosed in Japanese Priority Patent Application JP 2011-260059 filed in the Japan Patent Office on Nov. 29, 2011, the entire content of which is hereby incorporated by reference.

It should be understood by those skilled in the art that various modifications, combinations, sub-combinations, and alterations may occur depending on design requirements and other factors insofar as they are within the scope of the appended claims or the equivalents thereof.

What is claimed is:

1. A liquid crystal dimmer comprising:
a liquid crystal dimming device adjusting a transmitted light amount of incident picked-up image light;
a driving section supplying a drive voltage for driving the liquid crystal dimming device to the liquid crystal dimming device; and
a control section controlling the drive voltage to control a dimmed state of the liquid crystal dimming device,
wherein the control section controls the drive voltage to allow plural-stage shifting of a tilt angle of a liquid crystal molecule in the liquid crystal dimming device when the liquid crystal dimming device is caused to undergo a state transition from one dimmed state to another dimmed state, the dimmed states being different from each other in the transmitted light amount.

2. The liquid crystal dimmer according to claim 1, wherein
the control section controls the drive voltage to allow stepwise shifting of the tilt angle with one stage or a plurality of stages of intermediate state(s) included between an initial state as the one dimmed state and a target state as the another dimmed state.

3. The liquid crystal dimmer according to claim 2, wherein
when the tilt angle in the initial state is θi, the tilt angle in the intermediate state is θm, and the tilt angle in the target state is θt, the angle θm has a value between a value of the angle θi and a value of the angle θt.

4. The liquid crystal dimmer according to claim 3, wherein
the angle θm has a value between a value of (|θt−θi|/2) and the value of the angle θt.

5. The liquid crystal dimmer according to claim 2, wherein
the control section changes a period of the intermediate state depending on a temperature near the liquid crystal dimming device.

6. The liquid crystal dimmer according to claim 5, wherein
the control section controls the period of the intermediate state to be relatively long with decreasing the temperature near the liquid crystal dimming device.

7. The liquid crystal dimmer according to claim 5, wherein
the control section controls the period of the intermediate state by using a temperature control table making the temperature near the liquid crystal dimming device in correspondence with the period of the intermediate state in advance.

8. The liquid crystal dimmer according to claim 2, wherein
the control section controls a temperature correction voltage to be superimposed on the drive voltage in the initial state, the temperature correction voltage correcting the tilt angle in the initial state depending on the temperature near the liquid crystal dimming device.

9. The liquid crystal dimmer according to claim 8, wherein
the control section controls the temperature correction voltage to almost fix the tilt angle in the initial state independently of the temperature near the liquid crystal dimming device.

10. The liquid crystal dimmer according to claim 9, wherein
the control section controls the temperature correction voltage to be relatively increased with decreasing the temperature near the liquid crystal dimming device.

11. The liquid crystal dimmer according to claim 1, wherein
the liquid crystal dimming device includes a liquid crystal layer containing the liquid crystal molecule, and
the tilt angle is an angle that defines tilting of the liquid crystal molecule in a thickness direction of the liquid crystal layer when an intra-layer direction of the liquid crystal layer is set as a reference.

12. The liquid crystal dimmer according to claim 11, wherein
the control section performs control to allow plural-stage shifting of the tilt angle in a state transition in which the tilt angle is decreased in state transitions from the one dimmed state to the another dimmed state.

13. The liquid crystal dimmer according to claim 1, wherein
the driving section supplies the drive voltage with pulse width modulation (PWM).

14. An image pickup unit comprising:
a liquid crystal dimming device adjusting a transmitted light amount of incident picked-up image light;
an image pickup device acquiring a picked-up image signal based on picked-up image light that exits from the liquid crystal dimming device;
a driving section supplying a drive voltage for driving the liquid crystal dimming device to the liquid crystal dimming device; and
a control section controlling the drive voltage to control a dimmed state of the liquid crystal dimming device,
wherein the control section controls the drive voltage to allow plural-stage shifting of a tilt angle of a liquid crystal molecule in the liquid crystal dimming device when the liquid crystal dimming device is caused to undergo a state transition from one dimmed state to another dimmed state, the dimmed states being different from each other in the transmitted light amount.

15. A method of driving a liquid crystal dimming device, the method comprising:
supplying a drive voltage to the liquid crystal dimming device to drive the liquid crystal dimming device, the liquid crystal dimming device adjusting a transmitted light amount of incident picked-up image light; and
causing the liquid crystal dimming device to undergo a state transition from one dimmed state to another dimmed state, the dimmed states being different from each other in the transmitted light amount, while controlling the drive voltage to allow plural-stage shifting of a tilt angle of a liquid crystal molecule in the liquid crystal dimming device.
